(19) United States
(12) Patent Application Publication
(10) Pub. No.: US 2010/0293822 A1
(43) Pub. Date: Nov. 25, 2010

(54) Biblical Greeting Cards

(76) Inventor: Nicholas M. Reid, Laguna Niguel, CA (US)

Correspondence Address: LAW OFFICE OF ERIC B. ALSPAUGH, 26895 ALISO CREEK ROAD SUITE B 223, ALISO VIEJO, CA, 92656, US

(21) Appl. No.: 12/784,363

(22) Filed: May 20, 2010

Related U.S. Application Data
(60) Provisional application No. 61/179,803, filed on May 20, 2009.

(51) Int. Cl. B42D 15/04

(52) U.S. Cl. 40/124.09

(57) ABSTRACT

The present invention relates generally to sending greeting cards and more particularly to greeting cards with references to religious verse that is to be looked up by the card's recipient.

### CROSS-REFERENCE TO RELATED APPLICATION

U.S. provisional application No. 61/179,803 dated May 20, 2009 the contents of which are hereby incorporated by reference.

### BACKGROUND OF THE INVENTION

The present invention relates in general to greeting cards that have references to religious text; but require the recipient of the card to look up the text to get the message being sent. Greeting cards have been popular for communicating love, affection, and other positive messages. Christian religious cards are very popular and often contain Bible verses to help deliver a sentiment from the sender with respect for their God to the recipient. However, as society has evolved rapidly in this digital age, faithful devotees have to some degree lost touch with the text of the Bible.

The digital age is firmly routed throughout the world, with an estimated 1.5 billion worldwide web users according to World Internet Usage Statistics News and Population Stats updated Dec. 31, 2008. There are numerous electronic greeting card resources available, for example U.S. patent application Publication No. US2009/0069929 to Nguyen et al. Nguyen discloses a kiosk system for users to send electronic greeting cards anywhere in the world that a recipient has access to a computer and the internet. Also, U.S. patent application Publication No. US2009/0083386 to Manwaring et al. discloses a system for searching a church database for media, including text and music, purchase the media, and deliver the media over the internet. The ease with which media is sent today has resulted in information overload to the recipient.

The above referenced applications and all other referenced patents are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

### SUMMARY OF THE INVENTION

The present invention relates in general to greeting cards that have references to religious text; but require the recipient of the card to look up the text. The present invention can function properly both in hard copy form or be delivered in electronic. The present invention is applicable to any recipient that has access to the text of a world religion whether in hard copy or electronic form; for example, the Bible, Qu'ran, or Upanishads.

It is to be understood that the foregoing general description and the following detailed description are exemplary and explanatory only and are not to be viewed as being restrictive of the present invention, as claimed. Further advantages of this invention will be apparent after a review of the following detailed description of the disclosed embodiments which are illustrated schematically in the accompanying drawings and in the appended claims.

### BRIEF DESCRIPTION OF THE FIGURES

In the following, embodiments of the present invention will be explained in detail on the basis of the drawings, in which:

FIG. 1 is a perspective view of a preferred embodiment of the front and back cover of a physical greeting card.

FIG. 2 is a perspective view of a preferred embodiment of the inside of a physical greeting card.

FIG. 3 is a perspective view of a preferred embodiment of an electronic greeting card.

### DETAILED DESCRIPTION

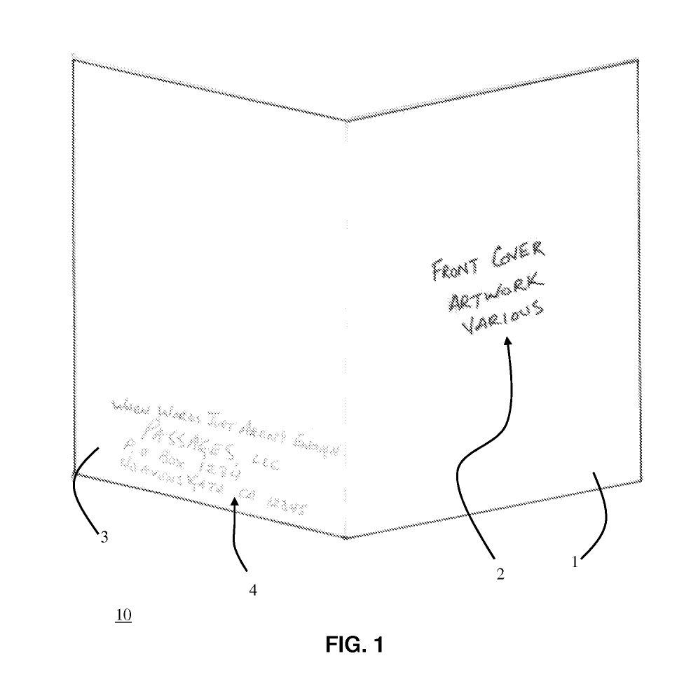

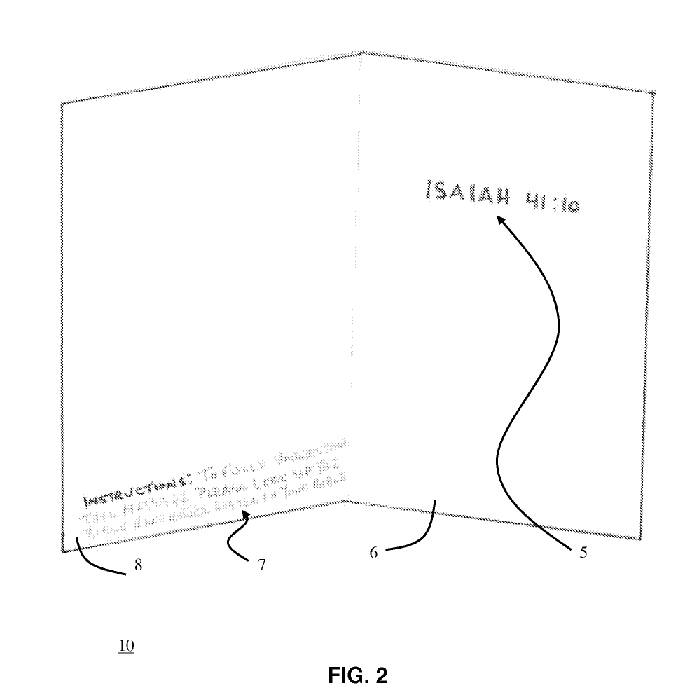

FIGS. 1 and 2 shows a preferred embodiment of a physical greeting card 10 with a reference 5 to Isaiah 41:10 on the inside surface 6 and an instruction 7 on the other inside surface 8 instructing the recipient to look up the text in their own Bible. The recipient would then look up and read the following religious text: “So do not fear, for I am with you; do not be dismayed, for I am your God. I will strengthen you and help you; I will uphold you with my righteous right hand.” The recipient would interpret the message from the sender in context of the sender's relationship with the recipient and the recipient's religion. For example, if the sender was aware that the recipient had been injured, the recipient of the greeting card would interpret the message as a get-well sentiment from the sender. Alternatively, if the sender was aware that the recipient had behaved badly, the recipient of the greeting card would interpret the message as encouragement to behave better.

While the present embodiment illustrates a typical greeting card 10 of a single card stock, folded evenly along its vertical axis, with preprinted text on the inside; the greeting card 10 could have text or images on any of the card surfaces and should not be construed to limit the invention. The instruction 7 instructing the recipient to look up the religious text could include additional instructions for example; look up the text at a certain time, certain date, certain place, or with a certain person. The front cover 1 of a greeting card 10 could have artwork, text, or a message 2 pre-printed. The back cover 3 of a greeting card 10 could be pre-printed artwork, text, or a message 4.

Alternatively, the greeting card 10 could have an instruction 7 for the recipient to look up a specific internet website or webpage. The website or webpage could have the religious text. Additionally, the website or webpage could utilize multimedia such as pictures, music, and or video to deliver the religious text and message.

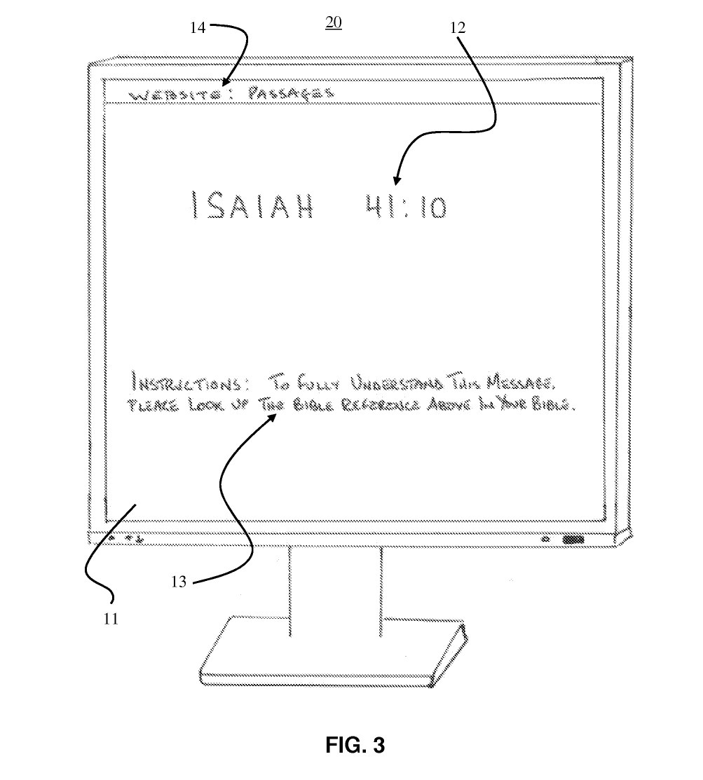

FIG. 3 illustrates an electronic greeting card 20 on a computer screen 11 with a reference 12 to religious text and instructions 13. Website address 14 could have a unique or secure address.

Alternatively, an electronic greeting card sender would select the religious text reference 12 and is optionally given a field for additional instructions 13. Examples of additional instructions would be the time of day, on a certain date, with a certain person, or at a certain place on which the recipient should read the referenced religious text. A sender could in the alternative place a personalized message in the field for additional instructions.

Although the greeting cards disclosed above are with text references from the Christian Bible; the invention includes references to all religious texts.

The foregoing description is, at present, considered to be the preferred embodiments of the present discovery. However, it is contemplated that various changes and modifications apparent to those skilled in the art, may be made without departing from the present discovery. Therefore, the foregoing description is intended to cover all such changes and modifications encompassed within the spirit and scope of the present discovery, including all equivalent aspects.

I claim:

1. A greeting card comprising a reference to religious text.

2. (canceled)

3. (canceled)

4. (canceled)

5. An electronic greeting card comprising a reference to religious text.

6. (canceled)

7. (canceled)

8. (canceled)

9. A greeting card comprising a reference to religious text and having a space for a sender to add additional text so that a recipient will interpret a unique message from the sender.

10. (canceled)

11. The greeting card as in claim 1, further comprising instructions to look up the text.

12. The greeting card as in claim 11, wherein the reference to religious text and instructions to look up the text are in a recipient's physical religious text.

13. The greeting card as in claim 11, wherein the reference to religious text and instructions to look up the text are delivered via the internet wherein the text could include multimedia.

14. The electronic greeting card as in claim 5, further comprising instructions to look up the text.

15. The electronic greeting card as in claim 14, further comprising a field for a sender to input additional instructions.

16. The electronic greeting card as in claim 14, wherein the reference to religious text and instructions to look up the text are in a recipient's physical religious text.

17. The electronic greeting card as in claim 14, wherein the reference to religious text and instructions to look up to the text are delivered via the internet wherein the text could include multimedia.
